(19) United States
(12) Patent Application Publication
(10) Pub. No.: US 2021/0150492 A1
(43) Pub. Date: May 20, 2021

(54) ELECTRONIC TIPPING SYSTEM

(71) Applicant: Gina Grossi-Marshall, Granada Hills, CA (US)

(72) Inventor: Gina Grossi-Marshall, Granada Hills, CA (US)

(21) Appl. No.: 16/953,312

(22) Filed: Nov. 19, 2020

Related U.S. Application Data
(60) Provisional application No. 62/937,384, filed on Nov. 19, 2019.

(51) Int. Cl. G06Q 20/02; G06Q 20/08; G06Q 20/10; G06Q 10/10; G06Q 20/32; G06Q 20/40; G06F 9/54

(52) U.S. Cl. CPC G06Q 20/02; G06Q 20/085; G06Q 20/108; G06F 9/541; G06Q 20/3267; G06Q 20/3223; G06Q 20/4015; G06Q 10/105

(57) ABSTRACT

The present disclosure relates to a system for cashless and contactless electronic tipping that provides a plurality of user devices, where a first one of the plurality of user devices is capable of initiating a tip request that includes a tip amount and identifies a user of a second one of the plurality of user devices, and where the second one of the plurality of user devices is capable of receiving a notification that the tip amount has been received and credited to a second account associated with the user of the second one of the plurality of user devices, and one or more servers coupled to the plurality of user devices via a network, where at least one of the one or more servers is capable of receiving the tip request and, upon validating the tip request, causing the tip amount to be deducted from a first account associated with a user of first one of the plurality of user devices and credited to the second account associated with the user of the second one of the plurality of user devices.

### RELATED APPLICATIONS

The present application claims priority to U.S. Provisional Application No. 62/937,384, filed Nov. 19, 2019, entitled “Electronic Tipping System,” which is hereby incorporated by reference.

### TECHNICAL FIELD

The present disclosure relates generally to systems for making payments. More particularly, but not exclusively, this disclosure relates to systems for electronically tipping service providers and the like using mobile devices.

### SUMMARY OF THE INVENTION

Provided herein is a system for tipping service providers and others using a mobile device. In one embodiment, the system includes one or more servers connected to one or more user devices via a network. A server may be responsible for, among other things, handling tip requests received from the one or more user devices via the network. A server may include, without limitation, a web server, application server, cloud server, server cluster, file server, local server, remote server and/or database server, and may be located on a single machine or distributed across multiple machines. A network may include the Internet, Ethernet, POTS, WAN, LAN, public switch telephone network (PSTN), ISDN, DSL, fiber optics, satellite, coaxial cable, cellular, wired, wireless, fixed line, serial, parallel, and the like, or any combination thereof. A user device may include an electronic device, including portable computing devices such as smartphones, laptops, or tablets.

A mobile tipping application may be downloaded to a user device from a server, which allows a tipper to, among other things, initiate a tip request from his or her user device. The same mobile tipping application may be downloaded to a tippee user device from the server, which allows the tippee to, among other things, report his or her location and receive notifications that a tip has been received, in what amount, and from whom.

The one or more servers may be electronically and/or physically connected to one or more databases. A database may reside on a local server or separate server that is accessible to the one or more servers via the network or any other connection. A server may be configured to store, among other things, login information for tippers and tippees and identifying information for partners (i.e., employers) and their employees (i.e., tippees) on the database.

One or more payment systems and one or more partner systems may also be connected to the one or more servers via the network. In particular embodiments, a payment system may be a third-party payment system that receives a request from a server to approve the transfer of (and transfer) money from a tipper account of the payment system and deposits the money in a tippee account of the payment system and provide a validation response to the server making the request. In particular embodiments, a partner system may be implemented as a server or any other human resources platform and may provide, among other things, information about its employees (i.e., tippees) to a server. For example, partner system may provide a server with an employee's name, bank account information (e.g., the bank account used by the partner for direct depositing the employee's paycheck), and the like. Such information may be used by a server to process a tip for a partner's employee.

### BRIEF DESCRIPTION OF DRAWINGS

FIG. 1a is a schematic diagram of an exemplary electronic tipping system.

FIG. 1b is a schematic diagram of the electronic tipping system of FIG. 1a, further including a payment system and one or more partner systems.

FIG. 2 is a representative flow diagram of exemplary operations of the electronic tipping system of FIGS. 1a and 1b.

FIG. 3 is a schematic diagram of an exemplary electronic tipping system including multiple payment systems.

### DETAILED DESCRIPTION

A detailed description of systems consistent with embodiments of the present disclosure is provided below. While several embodiments are described, it should be understood that the disclosure is not limited to any one embodiment, but instead encompasses numerous alternatives, modifications and equivalents. Additionally, while numerous specific details are set forth in the following description to provide a thorough understanding of the embodiments disclosed herein, some embodiments can be practiced without some or all of these details. Moreover, for the purposes of clarity, certain material that is known in the related art has not been described in detail to avoid unnecessary obscuring the disclosure.

The description may use the terms “embodiment” or “embodiments,” which may each refer to one or more of the same or different embodiments. The terms “comprising,” “including,” “having,” and the like, as used with respect embodiments, are synonymous, and are generally intended as “open” terms—e.g., the term “includes” should be interpreted as “includes but is not limited to,” the term “including” should be interpreted as “having at least,” The terms “transmitting,” “rendering,” “sending,” “serving,” “receiving,” “generating,” “processing,” “providing,” and the like, refer to the actions and/or processes of a computer system, computer, or electronic device, that manipulates and/or transforms data within the memory or registers of a computer system, computer, or electronic device.

Regarding the use of any plural and/or singular terms herein, those of skill in the relevant art can translate from the plural to singular and/or from the singular to the plural as is appropriate to the context and/or application. The various singular and/or plural permutations may be expressly set forth herein for the sake of clarity. The embodiments of the disclosure may be understood by reference to the drawings, wherein like party may be designated by like numerals. The elements of the disclosed embodiments, as generally described and illustrate in the figures herein, could be arranged and designed by like numerals. The elements of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure. In addition, the steps of any method disclosed herein do not necessarily need to be executed in any specific order, or even sequentially, nor need the steps be executed only once, unless otherwise specified.

Consistent with various embodiments disclosed herein, systems and methods of the present disclosure may be implemented using one or more computers or other electronic devices, including portable computing devices such as smartphones, laptops, or tablets; one or more servers such as web servers, application servers, cloud servers, server clusters, file servers, media servers, local servers, remote servers and database servers. The one or more computers or electronic devices may be able to communicate either directly or indirectly with other computer devices and/or one or more servers via intermediate devices and/or one or more networks such as the Internet, WANs, LANs, and the like. The one or computers or electronic devices may include internal communication means for communicating information, and one or more processors coupled to the communication means for processing such information. The one or more computers or electronic devices may also include memory (e.g., read only memory (ROM), random access memory (RAM), dynamic random-access memory (DRAM), main memory, etc.) coupled to a communication means (e.g., bus) for storing information and/or instructions to be executed by the one or more processors. The one or more computers or electronic devices may also be coupled to storage devices such as magnetic disks, optical disks, floppy disks, cloud servers, and the like.

The one or more computers or electronic devices may be able to interact with a user so that the user can view online multi-media content and purchase products associated with such multi-media content. This user interaction may be facilitated using a display device such as a liquid crystal display (LCD), light emitting diode (LED), and the like, that may be coupled to communication means for displaying information to a user. This user interaction may also be performed using a computer mouse, pen or stylus, or touch and/or voice commands. The methods and systems of the present disclosure can be implemented on any existing or future computer or electronic device with the processing capability to perform the functions described herein. Similarly, the scope of the present disclosure is not limited by the type of computer, electronic device, computer network, or computer hardware or software used.

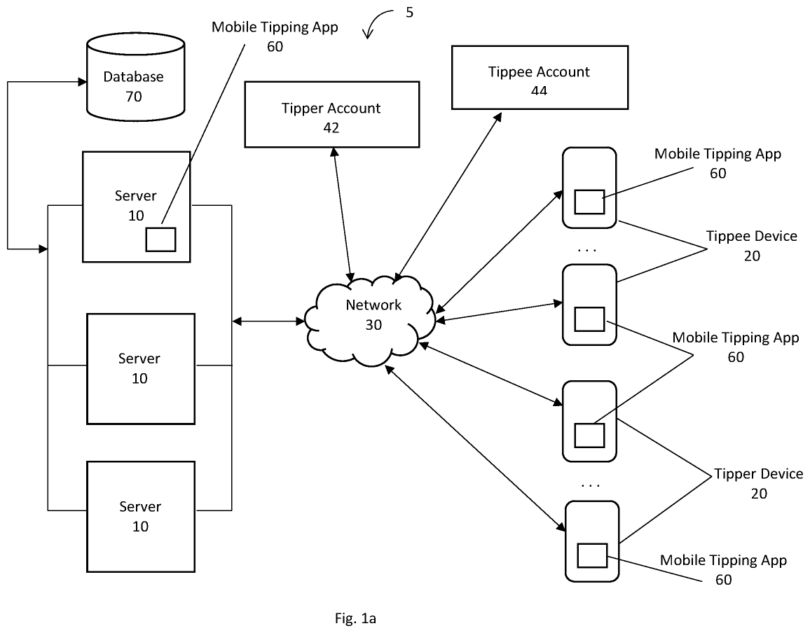

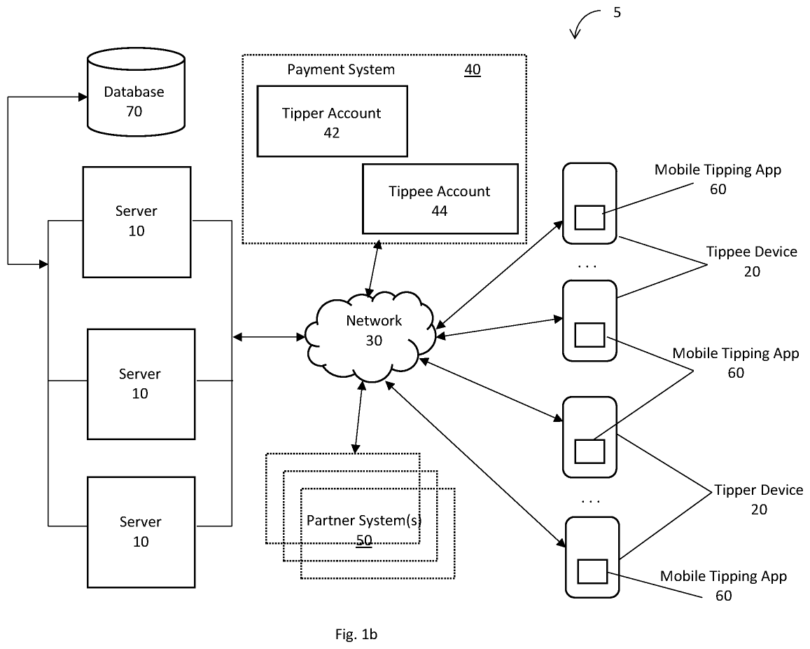

In today's world of electronic payments, people are carrying cash less often. Nevertheless, systems are needed that specifically address inefficiencies that may be associated with tipping individuals such as hotel valets, waiters, car wash attendants, massage therapists, and the like. Thus, a cashless and contactless system for electronically tipping service providers and the like is disclosed herein. In FIG. 1a, an exemplary electronic tipping system 5 is shown that includes one or more servers 10 connected to one or more user devices 20 (e.g., tipper or tippee devices) via a network 30. In various embodiments, as discussed below, a server 10 may be responsible for, among other things, handling tip requests received from the one or more user devices 20 via the network 30. Consistent with embodiments of the present disclosure, a network 30 may include the Internet, Ethernet, POTS, WAN, LAN, public switch telephone network (PSTN), ISDN, DSL, fiber optics, satellite, coaxial cable, cellular, wired, wireless, fixed line, serial, parallel, and the like, or any combination thereof.

In particular embodiments, multiple servers 10 may be distributed across different geographic availability zones, where each zone in a region has redundant and separate power, networking, and connectivity to reduce the likelihood of the tipping system going offline in the case of downtime in any specific availability zone. A server 10 may include, without limitation, a web server, application server, cloud server, server cluster, file server, local server, remote server and/or database server, and may be located on a single machine or distributed across multiple machines. In particular embodiments, a load balancer (not shown) may be used to balance the load across multiple servers 10 to manage requests from user devices 20.

As mentioned above, a server 10 may be configured to process requests received from a user device 20 to tip an individual. In other words, the server 10 may provide backend functionality for a tipping system 5 consistent with embodiments of the present disclosure. Such functionality may be handled via software (e.g., application software running on a server 10) and/or hardware. A server 10 may include internal communication means for communicating information, and one or more processors coupled to the communication means for processing such information. A server 10 may also include memory (e.g., read only memory (ROM), random access memory (RAM), dynamic random-access memory (DRAM), main memory, etc.) coupled to a communication means (e.g., bus) for storing information and/or instructions to be executed by the one or more processors.

In particular embodiments, a user device 20 may include an electronic device, including without limitation, portable computing devices such as smartphones, laptops, or tablets. A mobile tipping application 60 may be downloaded from a server 10 to a tipper device 20, which among other things, allows a tipper to sign on to the mobile tipping application 60, select tippees, initiate a tip request from his or her user device 20, and/or receive notifications regarding the same. The same mobile tipping application 60 may be downloaded from a server 10 to a tippee device 20, which allows the tippee to, among other things, sign on to the mobile tipping application 60, identify his or her employer (this may only have to be done once for each employer), manually notify the application 60 when s/he arrives at (or leaves) work, register his or her bank account information or other method of receiving payment (this may only have to be done once), turn on location services for his or her device 20 to let a tipper know when a tippee is working, and/or receive notifications that a tip has been received, in what amount, and from whom. Consistent with embodiments of the present disclosure, a tipper may be any individual and a tippee may be any individual who may provide a service to the tipper, including without limitation, a hotel valet, waiter, car wash attendant, massage therapist, and the like.

Once logged into the mobile application 60, a tipper may view a current list of tippees that is generated by a server 10. In one example, when a mobile tipping application 60 is first launched after being installed on a user device 20, tippees may be prompted to accept the location services permissions within the mobile tipping application 60. By accepting the location services permissions, a user device 20 may periodically update a server 10 with its location. In this case, a server 10 can automatically determine when an employee (i.e., tippee) is at work and add this employee to the list of employees that can be selected by a tipper. If location services permissions are not accepted by an employee (i.e., tippee), the employee may use the mobile tipping application 60 to manually notify a server 10 that s/he is a work and checked in, whereby the server 10 may add the tippee to the list of employees that may be selected on a tipper's user device 20. In particular embodiments, if an employee (tippee) is at work and checked in, the mobile tipping application 60 may display a green (or any other color/object) indicator next to the employee's name. If an employee (tippee) is not at work, the mobile tipping application 60 may display a red (or any other color/object) indicator. If, on the other hand, the employee's location cannot be determined, the mobile tipping application 60 may display a yellow or “x” (or any other color/object) indicator.

In particular embodiments, the one or more servers 10 may be electronically and/or physically connected to one or more databases 70. A database 70 may reside on a server 10 or may reside on a separate server (not shown) that is accessible to the one or more servers 10 via the network 30 or any other connection. A database 70 may store such information as a tipper's or tippee's login credentials, tippee's and tipper's bank account (or other payment information), a current list of tippees, and/or information about the tippee's employer (e.g., name, address, and so on). A database 70 may also store transactional information about tips received for a particular tippee—e.g., the number of tips received, the amount of each tip, and so on. It is important to note, however, that the database 70 may store any other information that may be relevant to handling tip requests from user devices 20.

As shown in FIG. 1b, in one embodiment, an electronic tipping system may include a secure payment system 40 that manages the transfer of monies from a tipper account 42 to a tippee account 44. In one embodiment, the payment system 40 may be a third-party payment system. In particular embodiments, the third-party payment system 40 may receive a request from a server 10 to approve the transfer of (and/or transfer) money from a tipper account 42 and deposit the money in a tippee account 44. In one embodiment, the third-party payment system 40 may move the tip monies from the tipper's account and float the monies until the tipper requests the tip monies from his or her account. In one embodiment, a payment system 40 and server 10 may communicate via an application program interface (API). It is important to note, however, that other APIs or communication protocols are possible consistent with embodiments of the present disclosure. It is also important to note that multiple payment systems may be used consistent with embodiments of the present invention. In some embodiments, a payment system may be server-based, including cloud servers.

As further shown in FIG. 1b, in one embodiment, one or more partner systems 50 may be connected to one or more servers 10 via the network 30. A partner may be an employer of a tippee (e.g., hotel, spa, car wash, restaurant etc.) In particular embodiments, a partner system 50 may be implemented as a server or any human resources or other platform where an employer maintains information about its employees (i.e., tippees). Here, tippees may not have to manually enter their bank account information, employer information, and the like via the mobile app 60, as such information may be supplied directly to a server 10 by a partner system 50. For example, partner system 50 may provide a server 10 with an employee's name, bank account information (e.g., the bank account used by the partner for direct depositing the employee's paycheck), and the like. Such information may be used by a server 10 to process a tip for the partner's employee. The communication between a partner system 50 and a server 10 may be implemented using simple object access protocol (SOAP), representational state transfer (REST), or any other protocol or architecture that facilitates the secure communication of information between a partner system 50 and a server 10.

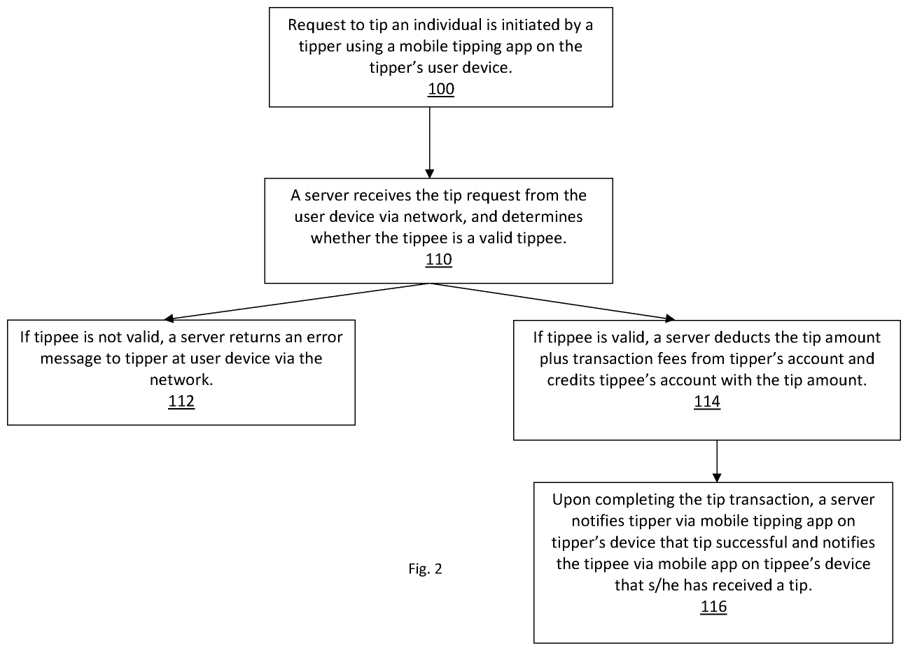

Turning now to FIG. 2, at 100, a request to tip an individual may be initiated by a tipper from a user device 20 via the mobile tipping application 60 (FIGS. 1a and 1b) that has been downloaded to (and resides) on the tippers's user device 20. The tip request may identify the individual to whom the tip is being sent (i.e., tippee) by selecting this individual from a list of individuals and specifying the tip amount. Using the mobile tipping application 60 on the tipper's user device 20, the tip request may be sent to a server 10 for processing.

In particular embodiments, at 110, once a server 10 receives a tip request, the server 10 may verify that the individual to whom the tip is being sent is valid person. The server 10 may also determine whether the individual to whom the tip is being sent is (or is not) currently at work. A server 10 may automatically determine whether a tippee by looking up the partner address for whom the tippee works, and comparing the partner's address to the tippee's user device 20 location. In this case, the tippee must have the location service of his or her user device 20 turned on so that the mobile tipping application 60 running on the tippee's user device 20 is periodically reporting the individual's user device 20 location to a server 10. Alternatively, if a tippee does not wish to have its location services turned on, s/he may manually notify a server 10 that s/he is at work via the mobile tipping application 60 running on the tippee's user device 20. If the individual (i.e., tippee) identified in a tip request is currently at work (or not at work), a message containing this information may be sent from a server 10 to the tipper user device 20 where it may be displayed to the tipper via a user interface of a mobile tipping application 60.

At 112, if the individual identified in a tip request is not valid—i.e., cannot be found in the database 70—an error message will be sent from a server 10 to the tipper's user device 20 where the message may be displayed to the tipper user via a user interface of the mobile tipping application 60 running on the tipper's user device 20.

At 114, if the individual identified in a tip request is valid, the server 10 may send a request to a payment system 40 to deduct the tip amount plus any related transaction fees from the tipper's account and credit the tipper's account in an amount equal to the tip amount specified in the tip request. If there are insufficient funds in the tipper's account to cover the transaction, an insufficient funds error message may be sent from by the payment system 40 to a server 10. The server 10 will, in turn, send a message to the tipper's user device 20 notifying the tipper (via the mobile tipping application 60 running on the tipper's user device 20) that the tip request was declined.

At 116, once a tip transaction is complete, the payment system 40 may notify a server 10 (or, in the case where no payment system 40 is being used, the server 10 itself will know) that the transaction is complete and, in turn, the server 10 may notify the tippee that s/he has received a tip by sending a message to the mobile tipping application 60 installed on the tippee's user device 20. It is important to note, however, that other approaches for completing a tip transaction are possible consistent with embodiments of the present disclosure.

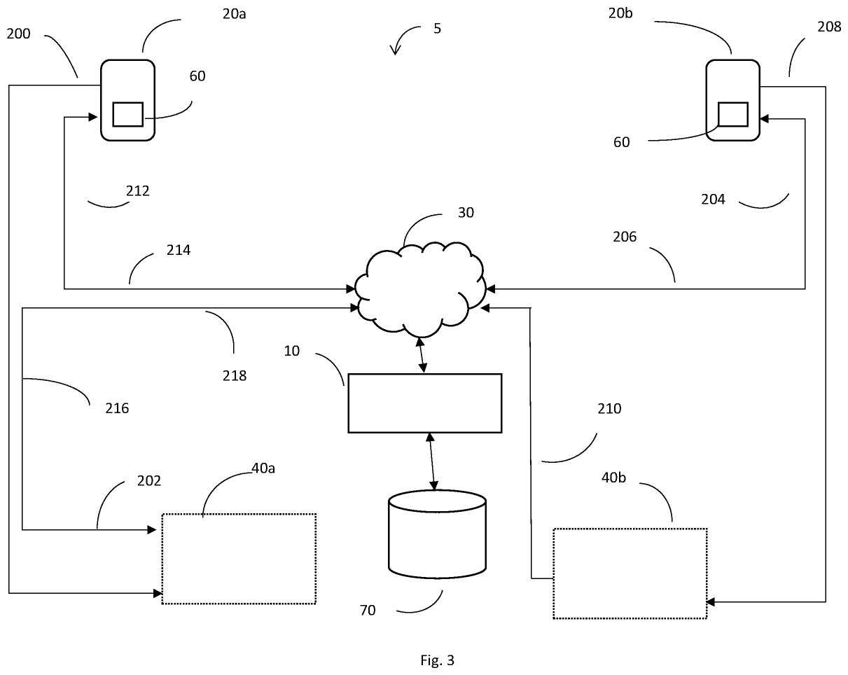

In FIG. 3, in another embodiment of the present disclosure, a tipping system 5 is shown including a payment system 40a and a payment system 40b, each coupled to a server 10 via network 30. As discussed above, a server 10 may include, without limitation, a web server, application server, cloud server, server cluster, file server, local server, remote server and/or database server, and may be located on a single machine or distributed across multiple machines. And more than one server 10 may be used.

A server 10 may be coupled to a database 70 that, as discussed above, may store such information as a tipper's or tippee's login credentials, identifying information for the tipper or tippee, tippee's and tipper's bank account (or other payment information), a current list of tippees, and/or information about the tippee's employer (e.g., name, address, and so on). A database 70 may also store transactional information about tips received for a particular tippee—e.g., the number of tips received, the amount of each tip, and so on. It is important to note, however, that the database 70 may store any other information that may be relevant to handling tip requests between a tipper and a tippee.

The server 10 may also be coupled to the tippee's user device 20a via a network 30. Similarly, the server 10 may be coupled to the tipper's user device 20b via a network 30. And, although not shown in FIG. 3, the user devices 20a, 20b may be coupled to payment systems 40a, 40b via a network 30. As discussed above, a network 30 may include the Internet, Ethernet, POTS, WAN, LAN, public switch telephone network (PSTN), ISDN, DSL, fiber optics, satellite, coaxial cable, cellular, wired, wireless, fixed line, serial, parallel, and the like, or any combination thereof. A user device 20a, 20b may include an electronic device, including portable computing devices such as smartphones, laptops, or tablets.

The payment system 40a may include any third party system or other system that is capable of receiving account information (e.g., banking account information or other account information) from a tippee, via a mobile application tipping application 60 on the tippee's user device 20a, and depositing a tip amount in an account associated with the tippee's account information. In one embodiment, the mobile tipping application 60 may communicate with the payment system 40a using an application program interface (API) of the payment system 40a, or some other method. In one embodiment, the payment system 40a may be a cloud-based or other server system.

The payment system 40b may include any third party system or other system that is capable of receiving payment information (e.g., bank account, credit card, or other payment information) from a tipper, via a mobile tipping application 60 on the tipper's user device 20b, and processing a payment corresponding to the tip amount using the tipper's payment information. In one embodiment, the mobile application 60 may communicate with the payment system 40b using an application program interface (API) of the payment system 40b, or some other method. In one embodiment, the payment system 40b may be a cloud-based or other server system.

Referring still to FIG. 3, at 200, a tippee may enter his or her account information via a mobile tipping application 60 on the tippee's user device 20a, where the tippee's account information is received by a payment system 40a via a network 30 using the mobile tipping application 60. In turn, at 202, the payment system 40a may send the tippee's account information to a server 10 (via an API or other communication method) where the tippee account information is then saved by the server 10 in a database 10. In another embodiment, the tippee's account information may be sent to the server 10 via the mobile tipping application 60, and the server 10 may send tippee's account information to the payment system 40a using a script or some other method. In another embodiment, as discussed above, a partner system 50 that is coupled to a server 10 via a network 30, may be used to provide the payment system 40a with a tippee's account information, either directly or via the server 10.

In one embodiment, the tippee's use of the mobile tipping application 60 requires the tippee to download the mobile tipping application 60 to his or her user device 20a and register as a user via the mobile tipping application 60. Typically, the tippee is only required to register once. A tippee that is registered via the mobile tipping application 60 may be visible to a tipper via the mobile tipping application 60 user interface, unless the tippee is not working or is not visible for some other reason.

Using a mobile tipping application 60 on the tipper' user device 20b, at 204, a tipper may select a tippee from a user interface of the mobile tipping application 60. In response to the tipper making this selection, at 206, the server 10 may respond by returning a unique identifier associated with the tippee to the mobile tipping application 60 on the tipper's user device 20b. This unique identifier, and a similar identifier associated with the tipper, may be used by a server 10 to ensure that the payment systems 40a, 40b debit a tip amount from the correct tipper account and post the tip amount to the correct tippee account. These identifiers may also be used to ensure that any tips that are being held in an account are also correctly moved from the holding account to the tippee's account using a payment system 40a.

In one embodiment, the tippers's use of the mobile tipping application 60 requires the tipper to download the mobile tipping application 60 to his or her user device 20a and register as a user via the mobile tipping application 60. Typically, the tipper must only register once.

At 208, the tipper may enter his or her payment information (e.g., bank account, credit card, or other payment information) and a tip amount via the mobile tipping application 60, which may cause the tipper's payment information and tip amount to be sent to a payment system 40b via a network 30 using the mobile tipping application 60 using an API of the payment system 40a (or other method). In another embodiment, the tipper's payment information may be sent directly to the server 10 via the mobile tipping application 60, and the server 10 may send the tipper's account information to the payment system 40b using a script or some other method.

At 210, the payment system 40b may process the tipper's payment for a tip amount, and send a confirmation to the server 10 via the network 30 that the payment has (or has not) been successfully processed. If the payment processing is successful, in one embodiment, the tip amount may post to an account where it is held for the tippee before being transferred to the tippee's account via payment system 40a. In another embodiment, if the payment processing is successful, the payment may post directly to the tippee's account.

At 212, if the payment processing mentioned immediately above is successful, the server 10 may notify the tippee via the mobile tipping application 60 on the tippee's user device 20a that the tippee has received a tip. This notification may include a tip amount and the name of the tipper. At 214, the mobile tipping application 60 on the tippee's user device 20a may send a request to the server 10 to post the tip amount to the tippee's account.

At 216, the server 10 may receive the request to post the tip amount to the tippee's account and instruct the payment system 40a to post the tip amount to the tippee's account. Once the tip amount is successfully posted to the tippee's account, the payment system 40a may send a message to the server 10 that the tip amount has been successfully posted to the tippee's account. In turn, in one embodiment, the server may inform the tipper and tippee (via the mobile tipping application 60) that the tip amount has been received in the tippee's account.

Although the foregoing has been described in some details for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein, but may be modified within the scope of equivalents of the disclosed embodiments.

What is claimed is:

1. A tipping system comprising:
a plurality of user devices, wherein a first one of the plurality of user devices is capable of initiating a tip request that includes a tip amount and information identifying a user of a second one of the plurality of user devices, and wherein the second one of the plurality of user devices is capable of receiving a notification that the tip amount has been received and credited to a second account associated with the user of the second one of the plurality of user devices;
one or more servers coupled to the plurality of user devices via a network, wherein at least one of the one or more servers is capable of receiving the tip request and, upon validating the tip request, causing the tip amount to be deducted from a first account associated with a user of the first one of the plurality of user devices and credited to the second account; and
a database coupled to the at least one of the one or more servers.

2. The tipping system of claim 1, further comprising a payment system coupled to the one or more servers via the network, wherein the at least one of the one or more servers is capable of sending the tip request to the payment system, wherein the payment system is capable of receiving the tip request and validating the tip request, wherein upon validation of the tip request, the payment system is capable of transferring the tip amount from the first account to the second account, wherein the at least one of the one or more servers is capable of using the validation response to send the notification.

3. The tipping system of claim 1, wherein the payment system is a third party payment system.

4. The tipping system of claim 3, wherein the at least one of the one or more servers is capable of sending the tip request to the payment system via an application program interface (API).

5. The tipping system of claim 3, wherein the payment system is capable of sending the validation response to the at least one of the one or more servers via an application program interface (API).

6. The tipping system of claim 1, further comprising at least one partner system coupled to the one or more servers via the network, wherein the at least one partner system maintains information about the user of the second one of the plurality of user devices, wherein the at least one partner system is capable of sending the information about the user of the second one of the plurality of user devices to the at least one of the one or more servers, and wherein the at least one of the one or more servers is capable of using the information about the user of the second one of the plurality of user devices to cause the tip amount to be credited to the second account.

7. The tipping system of claim 6, wherein the at least one partner system is capable of sending the information about the user of the second one of the plurality of user devices to the at least one or more servers using a secure communication method.

8. The tipping system of claim 7, wherein the secure communication method is selected from the group consisting of simple object access protocol (SOAP) and representational state transfer (REST).

9. The tipping system of claim 6, wherein the information about the user of the second one of the plurality of user devices comprises an account number associated with the second account.

10. The tipping system of claim 6, wherein the information about the user of the second one of the plurality of user devices comprises the information identifying the user of the second one of the plurality of user devices.

11. The tipping system of claim 6, wherein the at least one partner system is associated with an employer of the user of the second one of the plurality of user devices.

12. The tipping system of claim 11, wherein the at least one partner system is a human resources platform.

13. The tipping system of claim 11, wherein the at least one partner system is a server.

14. The tipping system of claim 1, wherein the first one of the plurality of user devices is capable of initiating the tip request via a mobile application, and wherein the second one of the plurality of user devices is capable of receiving the notification via the mobile application.

15. The tipping system of claim 14, wherein the mobile application is downloaded to the first one of the plurality of user devices from any one of the one or more servers, and wherein the mobile application is downloaded to the second one of the plurality of user devices from any one of the one or more servers.

16. The tipping system of claim 14, wherein the at least one of the one or more servers is capable of receiving information about the user of the first one of the plurality of user devices from the first one of the plurality of user devices via the mobile application, wherein the at least one of the one or more servers is capable of storing the information about the user of the first one of the plurality of user devices in the database, wherein the at least one of the one or more servers is capable of retrieving the information about the user of the first one of the plurality of user devices from the database, and wherein the at least one of the one or more servers is capable of using the information about the user of the first one of the plurality of user devices to validate the tip request, and cause the tip amount to be deducted from the first account and credited to the second account.

17. The tipping system of claim 16, wherein the information about the user of the first one of the plurality of user devices comprises an account number associated with the first account.

18. The tipping system of claim 17, wherein the information about the user of the first one of the plurality of user devices comprises a name of the user of the first one of the plurality of user devices.

19. The tipping system of claim 18, wherein the notification includes the name of the user of the first one of the plurality of user devices

20. The tipping system of claim 16, wherein the at least one of the one or more servers is capable of receiving information about the user of the second one of the plurality of user devices from the second one of the plurality of user devices via the mobile application, wherein the at least one of the one or more servers is capable of storing the information about the user of the second one of the plurality of user devices in the database, wherein the at least one of the one or more servers is capable of retrieving the information about the user of the second one of the plurality of user devices from the database, and wherein the at least one of the one or more servers is capable of using the information about the user of the second one of the plurality of user devices to validate the tip request, and cause the tip amount to be deducted from the first account and credited to the second account.

21. The tipping system of claim 20, wherein the information about the user of the second one of the plurality of user devices comprises an account number associated with the second account.

22. The tipping system of claim 20, wherein the information about the user of the second one of the plurality of user devices comprises a physical location of the user of the second one of the plurality of user devices.

23. The tipping system of claim 22, wherein the at least one of the one or more servers is capable of sending the physical location of the user of the second one of the plurality of user devices via the mobile application to the to notify the user of the first one of the plurality of user devices about whether the user of the second one of the plurality of user devices is presently at work.

24. The tipping system of claim 20, wherein the information about the user of the second one of the plurality of user devices comprises a name of an employer of the user of the second one of the plurality of user devices.

25. The tipping system of claim 24, wherein the information about the user of the second one of the plurality of users devices comprises a name of the user of the second one of the plurality of user devices, and wherein the information identifying the user of the second one of the plurality of user devices comprises the name of the user of the second one of the plurality of user devices

26. The tipping system of claim 1, further comprising a load balancer coupled between the network and the one or more servers.

27. The tipping system of claim 1, wherein the plurality of user devices are mobile devices.

28. The tipping system of claim 27, wherein the mobile devices are selected from a group consisting of smartphones, laptops, and tablets.
